(19) United States
(12) Patent Application Publication
(10) Pub. No.: US 2011/0166265 A1
(43) Pub. Date: Jul. 7, 2011

(54) HIGH STRUCTURE CARBON BLACK IN ELASTOMERIC POLYMERS AND METHOD FOR MAKING

(75) Inventors: Lawrence Douglas Harris, Baton Rouge, LA (US); Deepak Rasiklal Parikh, Beaumont, TX (US); Vernon Vincent Vanis, Spring, TX (US)

(73) Assignee: LION COPOLYMER, LLC, Baton Rouge, LA (US)

(21) Appl. No.: 12/984,322

(22) Filed: Jan. 4, 2011

Related U.S. Application Data
(60) Provisional application No. 61/292,932, filed on Jan. 7, 2010.

(51) Int. Cl. C08L 9/06; C08K 5/04; C08K 11/00; C08K 3/04; C08K 3/34; C08K 3/26; C08K 5/13; C08K 3/32; C08K 5/17

(52) U.S. Cl. 524/15; 524/575; 524/35; 524/65; 524/451; 524/426; 524/323; 524/414; 524/343; 524/186

(57) ABSTRACT

High structure carbon black-styrene butadiene compositions and methods for making such are provided herein. In addition, articles made from the high structure carbon black-styrene butadiene compositions are also provided. The method can include high shear grinding a carbon black comprising from 1 percent by weight to 50 percent by weight of high structure carbon black that forms shear ground carbon black, and combining the shear grinded carbon black with water to form a carbon black slurry.

### CROSS REFERENCE TO RELATED APPLICATIONS

The present application claims priority to and the benefit of U.S. Provisional Patent Application Ser. No. 61/292,932 filed on Jan. 7, 2010, entitled “HIGH STRUCTURE CARBON BLACK IN ELASTOMERIC POLYMERS AND METHOD FOR MAKING”. This reference is hereby incorporated in its entirety.

### FIELD

The present embodiments generally relate to a process for making a styrene butadiene polymer composition with a high structure carbon black, and to a high structure carbon black-styrene butadiene composition.

### BACKGROUND

A need exists for a simple and less expensive process for making a styrene butadiene polymer composition with a high structure carbon black.

A need exists for a styrene butadiene polymer composition that has better abrasion resistance for belts and tires, such as automotive and farm tires, while also maintaining impact strength durability and tread integrity.

A need exists for reducing the number of processing steps required to make a carbon black infused polymer of styrene and butadiene.

A need exists for better dispersion and incorporation of a carbon black into a polymer for improved tire characteristics or conveyor belt characteristics, such as improved impact resistance or improved durability.

The present embodiments meet these needs.

### BRIEF DESCRIPTION OF THE DRAWINGS

The detailed description will be better understood in conjunction with the accompanying drawing as follows:

FIG. 1 is a diagram of an embodiment of the method for making the styrene butadiene polymer composition.

FIG. 2 is a diagram of another embodiment of the method.

FIG. 3 is a diagram of yet another embodiment of the method.

The present embodiment is detailed below with reference to the listed Figures.

### DETAILED DESCRIPTION OF THE EMBODIMENTS

Before explaining the present process and composition in detail, it is to be understood that the process for making the styrene butadiene polymer composition is not limited to the particular embodiments and that it can be practiced or carried out in various ways.

The process can be used to produce a styrene butadiene polymer composition with a high structure carbon black. The composition is also referred to herein as a “high structure carbon black-styrene butadiene composition”.

The high structure carbon black-styrene butadiene composition can have a molecular weight equal to that of a styrene butadiene rubber (SBR) with a Mooney unit determined as MS 1+4 at 100 degrees Celsius.

The term “polymer of styrene and butadiene”, as used herein, refers to copolymers that are chemically bound and/or crosslinked alpha olefin polymers having a range of 5 percent to 50 percent by weight of styrene and a range of 50 percent to 95 percent of butadiene by weight. The butadiene can be liquid 1,3-butadiene.

The polymers can be natural polymers or synthetic polymers. The term “natural polymer”, as used herein, refers, at least in part, to polymers that are derived from a rubber obtained from botanical sources.

The term “synthetic polymer”, as the term is used herein, refers, at least in part, to any material possessing the properties of a rubber but produced from other than natural botanicals, such as those produced from fossil fuels.

Mixtures of natural and synthetic polymers can be used in one or more embodiments.

The term “high structure”, as used in the phrase “high structure carbon black-styrene butadiene composition” refers, at least in part, to a carbon black with a high nitrogen area on the surface, such as a nitrogen surface area that exceeds 50 square meters per gram. The term “high structure”, as used in the phrase “high structure carbon black-styrene butadiene composition” also refers to a carbon black with an oil absorption number (OAN) that is in excess of 110 ml/100 g as determined using ASTM standard 2414, in effect as of December 2010.

The method can include incorporating a silica reinforcing agent, fillers, such as carbon blacks, or combination thereof into natural polymers and/or synthetic polymers.

The silica, or silica reinforcing agent, can be substantially uniformly dispersed within the natural polymers and/or synthetic polymers, and can compatibilize or react with the polymer matrix of the natural polymers and/or synthetic polymers during processing for end use.

The silica can be silica with a particulate size ranging from 0.1 micron to 10 microns.

The content of silica can range from about 1 part silica per 100 parts polymer to about 2 parts silica per 1 part polymer.

The fillers can be clays, diatomaceous earth, mica, ground pecan shells, finely ground solid materials or fibers, synthetic fillers, natural fillers, and the like.

The fillers can be blended in ratios of from about 1 percent to about 80 percent by weight of filler with respect to the polymer concentration.

The natural and synthetic polymers can include rubber and thermoplastic polymers made in latex form. The term “latex form”, as used herein, refers to an aqueous/colloid of rubber particles.

The synthetic polymers that can be used with the method can include synthetic polymers made by polymerizing or copolymerizing conjugated diene monomers, such as butadiene, isoprene, chloroprene, pentadiene, dimethylbutadiene, and the like.

The polymerizations can be completed using pinane hydroperoxide at temperatures ranging from about 1 degree Celsius to about 25 degrees Celsius.

The conversion rates can be from about 59 percent to about 80 percent for the polymers.

The method can be implemented using polymers made in latex form, which can include: conjugated diene-based polymers, polymers based on vinyl monomers, and combinations of conjugated dienes with vinyl monomers. Vinyl monomers that can be used in the method can include: styrene, alpha-methylstyrene, alkyl substituted styrenes, vinyl toluene, divinylbenzene, acrylonitrile, vinylchloride, methacrylonitrile, isobutylene, maleic anhydride, acrylic esters and acids, methylacrylic esters, vinyl ethers, vinyl pyridines, and the like. Specific polymers are exemplified by natural rubber, styrene-butadiene rubber (SBR), acrylonitrile-butadiene rubber (NBR), acrylonitrile-butadiene-styrene polymer (ABS), polybutadienes, polyvinylchloride (PVC), polystyrene, polyvinylacetate, butadiene-vinyl pyridine polymers, polyisoprenes, polychloroprene, neoprene, styrene-acrylonitrile copolymer (SAN), blends of acrylonitrile-butadiene rubber with polyvinylchloride, and the like.

The method can be carried out by forming polymer latexes, to which other fillers can be added, such as carbon black. As such, silica-carbon black compositions can be attainable with uniform high loads of total filler and quantitative incorporation of the fillers.

The method can include high shear grinding of a high structure carbon black, such as about 1 percent by weight to about 50 percent by weight of high structure carbon black, forming a shear grinded carbon black.

High shear grinding can form carbon black particulate having a diameter from about 0.5 micron to about 100 microns. The grinding can be used in a continuous flow process.

In one or more embodiments, the carbon black can be or include an ASTM 100 series carbon black. Carbon black, as the term is herein used, is virtually pure elemental carbon in the form of colloidal particles that are produced by incomplete combustion or thermal decomposition of gaseous or liquid hydrocarbons under controlled conditions. The physical appearance of carbon black is that of a black, finely divided pellet or powder. Carbon black can be used in tires, rubber, plastic products, printing inks, and coatings related to properties of specific surface area, particle size and structure, conductivity, and color.

The specific surface area of the carbon black can be from about 50 square meters per gram to about 170 square meters per gram, and the particle size can be from about 0.5 micron to about 100 microns.

The high shear grinding can include reducing the diameter of particulate of carbon black at a pressure by using steam, such as a JET-O-MIZER™; achieving a smaller diameter or overall size. The high shear grinding can be performed using various methods.

When the high shear grinding is performed using steam, the temperature of the steam can be about 150 degrees Celsius, and a pressure of the steam can range from about 85 psig to about 135 psig.

In one or more embodiments, the high shear grinding can be at least partially performed using ball mill grinding, hammer mill grinding, cryogenic grinding, or mechanical grinding.

The shear grinded carbon black can be combined with water to form a carbon black slurry.

The water can be tap water, distilled water, mineral water, or heavy water.

The carbon black slurry can include from about 1 percent to about 13 percent by weight solids in water.

For a volume of water of 1 liter, the carbon black slurry can have 4 percent to 10 percent by weight solids of carbon black.

The water can be distilled water in the liquid phase or in a mixed phase. For example, the water can be a liquid at a temperature of about 85 degrees Celsius with vapor at a pressure from about ambient pressure to about 2 atm.

The method can also include creating a rubber latex slurry, which can be used to make the composition.

The rubber latex slurry can include a rubber portion and an aqueous portion. The rubber portion can have from about 9 percent by weight to about 40 percent by weight of styrene, and from about 60 percent by weight to about 91 percent by weight of butadiene.

The aqueous portion can further include water, soaps, emulsifiers, thickeners, surfactants, viscosity modifiers, starch, carboxy methyl cellulose (CMC), or combinations thereof.

For example, the aqueous portion can be 1 liter of soapy water with about 10 percent by weight of a soap, such as fatty acid or rosin acid soap, and about 90 percent by weight tap water at 70 degrees Celsius. A solids content of the soap in the water can be about 22 percent by weight.

In one or more embodiments, the rubber latex slurry can have at least 2 percent by weight solids that can precipitate out if allowed to settle over an extended period of time.

The solids can be or include fillers, such as talc. The talc can be in flake or powder form.

The method can also include blending the carbon black slurry into the rubber latex slurry, which forms a carbon black rubber latex slurry.

The carbon black slurry can be blended by providing the rubber latex slurry at a feed rate of up to 400,000 lbs per hour into a vessel for blending. The feed rate can vary depending on the rate of coagulation of the polymer.

The vessel or reactor can have a volume of about 40,000 gallons.

The rubber latex slurry can be provided to the reactor at a similar feed rate to the carbon black slurry.

In one or more embodiments, one or more additional components can be blended with the carbon black slurry and the rubber latex slurry in the reactor.

The blending can be performed using impeller agitation.

In embodiments, a compatibilized silica can be provided to the reactor along with the carbon black slurry and the rubber latex slurry using a separate nozzle or entry port.

Fillers can be added to the reactor along with the carbon black slurry in an amount ranging from about 1 percent by weight to about 50 percent by weight. The filler can be or include ground pecan shells, diatomaceous earth, silage, cellulosic materials, ground peanut shells, talc, ground coal, ground bagasse, ash, perlite, clay, calcium carbonate, biomass, or combinations thereof.

Antioxidants can be added to the reactor along with the carbon black slurry. The antioxidant can be or include a phenolic antioxidant, a phosphite, a bisphenol, an amine, or combinations thereof.

From about 0.01 percent to about 2 percent by weight of the antioxidant, such as Flexzone 134, can be added per 88 percent to 99.99 percent by weight of the styrene butadiene polymer.

The carbon black slurry, the rubber latex slurry, and the additional components can be provided to the reactor simultaneously or concurrently.

In embodiments, the carbon black slurry can be first inserted into the reactor and then the rubber latex slurry can be introduced to the reactor for blending. Then, subsequent fillers, antioxidants, and stabilizers can be added in sequence for full and complete blending.

The mixing vessel or “reactor” can be operated at a temperature up to 65 degrees Celsius. A temperature range can be from about 0 degree Celsius to about 5 degrees Celsius for a vessel with a volume from about 0.1 gallon to about 40,000 gallons of liquid with 10 percent by weight carbon black slurry and 22 percent by weight rubber latex slurry.

The carbon black slurry and the rubber latex slurry can be mixed for from about 0.5 hours to about 5 hours at a rate of at least 12,000 pounds per hour using a high rate of agitation.

The process of blending can be a continuous process.

After the formation of the carbon black rubber latex slurry, the carbon black rubber latex slurry can coagulate to form the styrene butadiene polymer composition.

Coagulation, as the termed is used herein, refers to at least a 22 percent formation of a gooey mass with 78 percent of liquid remaining.

Coagulating the carbon black rubber latex slurry can include providing coagulation aids, such as sulfuric acid, muriatic acid, acetic acid, citric acid, and other acids.

The coagulation aids can be added in small mounts.

The coagulation aids can be in aqueous form with a liquids content of no more than 50 percent, or powder form.

After the formation of the styrene butadiene polymer composition, the styrene butadiene polymer composition can be dried.

The drying of the styrene butadiene polymer composition can be performed using an evaporator, a dehydrator, a drying oven, or a fluid bed dryer that is a continuous drying device, enabling 24 hours a day, 7 days a week drying. Convective heat exchange, such as moving hot air, can be used to dry the polymer.

The styrene butadiene polymer composition can be dried at a temperature of about 140 degrees Celsius to about 200 degrees Celsius.

The drying can be performed using a residence time of about 20 minutes depending on the length of the dryer. The styrene butadiene polymer composition can take longer, such as about 3 hours if the styrene butadiene polymer composition is very thick. Generally from about 3000 pounds to about 5000 pounds can be dried simultaneously.

For example, the drying can remove water in the styrene butadiene polymer composition until less than 2 percent by weight of water exists in the styrene butadiene polymer composition.

The method can also include adding from about 5 percent by weight to about 80 percent by weight compatibilized silica with at least 1 percent by weight of a coupling agent to at least one of the carbon black slurry, the rubber latex slurry, or the carbon black rubber latex slurry.

The coupling agent can be an organosilicon compound, such as Si69 made by Momentum.

Illustrative coupling agents can include synthetic polymer, including: trialkylsilanes, dialkylsilanes, trialkylalkoxysilanes, trialkylhalosilanes, dialkyalkoxysilanes, dialkyldialkoxysilanes, dialkylalkoxyhalosilanes, trialkylsilanols, alkyltrialkoxysilanes, alkyldialkoxysilanes, alkyldialkoxyhalosilanes, and monoalkylsilanes, with the alkyl group being a C.sub.1 to C.sub.18 linear, cyclic, or branched hydrocarbon, or combinations thereof.

In one or more embodiments, one or two alkyl groups of the coupling agent can be replaced with a phenyl or benzyl group, or one to two alkyl groups can be replaced with a phenyl, benzyl, or alkoxy substituted alkyl group.

A bispolysulfides can be used as the coupling agent, such as bis(trialkoxysilylalkyl) polysulfide containing from 2 sulfur atoms to 8 sulfur atoms in which the alkyl groups are C.sub.1-C.sub.18 alkyl groups and the alkoxy groups are C.sub.1-C.sub.8 alkoxy groups.

In carrying out one or more embodiments of the method, the silica and the coupling agent can be dissolved in a lower alkanol, such as propanol or ethanol, at a pH below 9 and within the range from 3 to 9. Water can be slowly added, either continuously or incrementally.

While water is added, hydrolysis of the hydrolyzable groups contained in the coupling agent can occur, which forms a corresponding silanol.

To assist in the hydrolysis of an alkoxy group, a pH in the range of 3.5-5.0 can be maintained to minimize side reactions, such as oligomerization of the organosilane. This pH range can be maintained by use of a dilute mineral acid, such as hydrochloric or weak organic acids such as acetic acid.

To assist in the hydrolysis of a hydride group, more alkaline conditions can be used, and bases, such as KOH, NaOH, NH.sub.40H, triethylamine, or pyridine can be employed to maintain a pH of 8-9. The choice of base can depend on the chemical nature of the specific latex to which the silica slurry is added.

When the hydrolyzable group is halogen, the organohalo-silane can be mixed directly with the aqueous silica dispersion rather than carrying out a separate hydrolysis step. The hydrolyzed coupling agent can then be blended with an aqueous slurry of the finely divided silica, whereby the silanol groups present in the coupling agent chemically react with the surface of the silica to form a siloxane bond (Si—O—Si) between the coupling agent and the silica surface.

In embodiments, the pH can be maintained from approximately 5.5 to 6.5 to favor a reaction with the silica surface, while allowing some condensation reaction between the silane molecules bonding to the surface of the silica. Depending on the particular silica and the initial pH of the water, a desired pH is attained without addition of further reagents.

In one or more embodiments, the method can include adding from 1 percent by weight to 40 percent by weight extender oil to at least one of the carbon black slurry, the rubber latex slurry, or the carbon black rubber latex slurry. The extender oil can be or include a synthetic oil, aromatic oil, naphthenic oil, a hydrocarbon based oil, polycyclic aromatic hydrocarbon oil (PAH), or combinations thereof.

In one or more embodiments, the styrene butadiene polymer composition can be used to make an article.

The article formed from the styrene butadiene polymer composition can include a floor mat, a tire, a belt, a roller, a gasket printer's roller, an o-ring, shoes, footwear, wire and cable jacketing, roofing edging, a tubular, such as a garden hose or pipe, a marine impact bumper, such as a side bumper used for the docking of a boat, an industrial belt, non-latex gloves, non-automotive tires, a mining belt, bearings, a gas mask, or a conduit. For example, the article can be a pneumatic tire used on bikes, cars, or airplanes.

### Example 1

A styrene butadiene polymer composition with a high structure carbon black can be made by high shear grinding a carbon black comprising 20 percent by weight of high structure carbon black, which forms shear ground carbon black. The high shear grinding can be performed using a ball mill grinding unit.

The carbon black comprising 20 percent by weight of high structure carbon black can be high shear ground for about 20 minutes.

After the shear ground carbon black is formed, the shear ground carbon black can be combined with well water at a temperature of 50 degrees Celsius and a pressure of 1 atm. The shear ground carbon black can be added to the water at the rate at which the carbon black is ground.

The method can also include making a rubber latex having a rubber portion and an aqueous portion. For example, styrene can be polymerized with butadiene using a catalyst.

The rubber portion can have 25 percent by weight of styrene and 71 percent by weight of butadiene. In addition, the rubber latex slurry can include 4 percent by weight of a solid.

The carbon black slurry can be mixed or blended with the rubber latex slurry, which forms a carbon black rubber latex slurry, at a continuous rate in a tank, such as a 1000 gallon tank.

The blending of carbon black slurry and the rubber latex slurry can be performed for about 40 minutes at a temperature of 65 degrees Celsius and a pressure of 1 atm.

The carbon black rubber latex slurry can be coagulated, mixed, and then moved from the first tank to a second tank with additional agitation. Acids and coagulation aids can be continuously added to form the styrene butadiene polymer composition.

Once coagulated, the coagulated wet styrene butadiene polymer composition can be dried, first by processing through a spin dryer to remove most of the water, and then the spin dried polymer can be passed through a fluid bed dryer to remove the rest of the water.

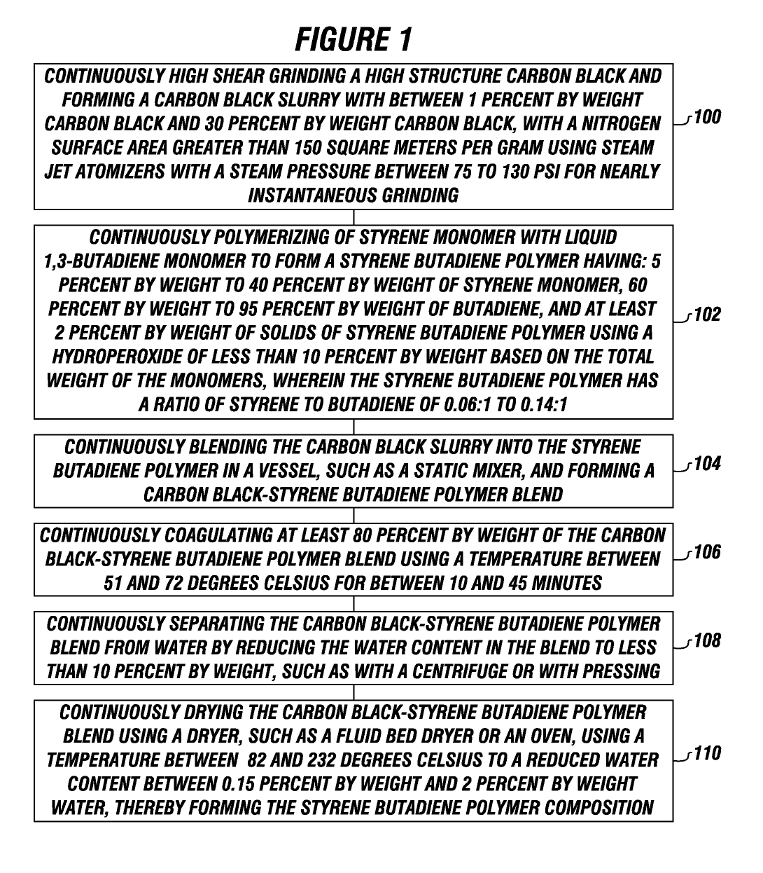

FIG. 1 shows a diagram of an embodiment of the method.

Step 100 can include continuously high shear grinding a high structure carbon black and forming a carbon black slurry with between 1 percent by weight carbon black and 30 percent by weight carbon black, with a nitrogen surface area greater than 150 square meters per gram using steam jet atomizers with a steam pressure between 75 psi to 130 psi for nearly instantaneous grinding.

Step 102 can include continuously polymerizing of styrene monomer with liquid 1,3-butadiene monomer to form a styrene butadiene polymer having: 5 percent by weight to 40 percent by weight of styrene monomer, 60 percent by weight to 95 percent by weight of butadiene, and at least 2 percent by weight of solids of styrene butadiene polymer using a hydroperoxide of less than 10 percent by weight based on the total weight of the monomers, wherein the styrene butadiene polymer has a ratio of styrene to butadiene of 0.06:1 to 0.14:1.

Step 104 can include continuously blending the carbon black slurry into the styrene butadiene polymer in a vessel, such as a static mixer, and forming a carbon black-styrene butadiene polymer blend.

Step 106 can include continuously coagulating at least 80 percent by weight of the carbon black-styrene butadiene polymer blend using a temperature between 51 degrees Celsius and 72 degrees Celsius for between 10 minutes and 45 minutes.

Step 108 can include continuously separating the carbon black-styrene butadiene polymer blend from water by reducing the water content in the blend to less than 10 percent by weight, such as with a centrifuge or with pressing.

Step 110 can include continuously drying the carbon black-styrene butadiene polymer blend using a dryer, such as a fluid bed dryer or an oven, using a temperature between 82 degrees Celsius and 232 degrees Celsius to a reduced water content between 0.15 percent by weight and 2 percent by weight water, thereby forming the styrene butadiene polymer composition. The styrene butadiene polymer composition can have a Mooney unit ranging between 40 and 90 measured at MS 1+4 at 100 degrees Celsius and at a continuous flow rate of at least 3000 pounds of styrene butadiene polymer composition per hour and up to 20,000 pounds of styrene butadiene polymer composition per hour.

One or more embodiments can involve adding a compatibilized silica to the vessel. The compatibilized silica can have at least 1 percent by weight coupling agent to the carbon black slurry, the styrene butadiene polymer, or combinations thereof, and the compatibilized silica can be added in an amount between 25 percent and 80 weight percent.

Embodiments can include adding a silica to the vessel with at least 1 percent by weight coupling agent to the carbon black slurry, the styrene butadiene polymer, or combinations thereof. The silica can be added in amounts between 25 percent and 80 weight percent.

Embodiments can involve using between 1 percent and 15 percent by weight coupling agent.

Embodiments an include using, as the coupling agent, an organosilicon compound.

Embodiments can include high shear grinding using a ball mill grinding, hammer mill grinding, cryogenic grinding, mechanical grinding, or combinations thereof, and then adding water to form the carbon black slurry.

Embodiments can include using, as the high structure carbon black, an ASTM 100 series carbon black according to ASTM 2010 standards.

Embodiments can include a carbon black slurry with from 1 percent by weight to 13 percent by weight carbon black solids in water.

Embodiments can include drying to remove water from the styrene butadiene polymer until less than 2 percent by weight water exists in the styrene butadiene polymer.

Embodiments can include chemically binding and/or cross-linking the styrene monomer with butadiene monomer.

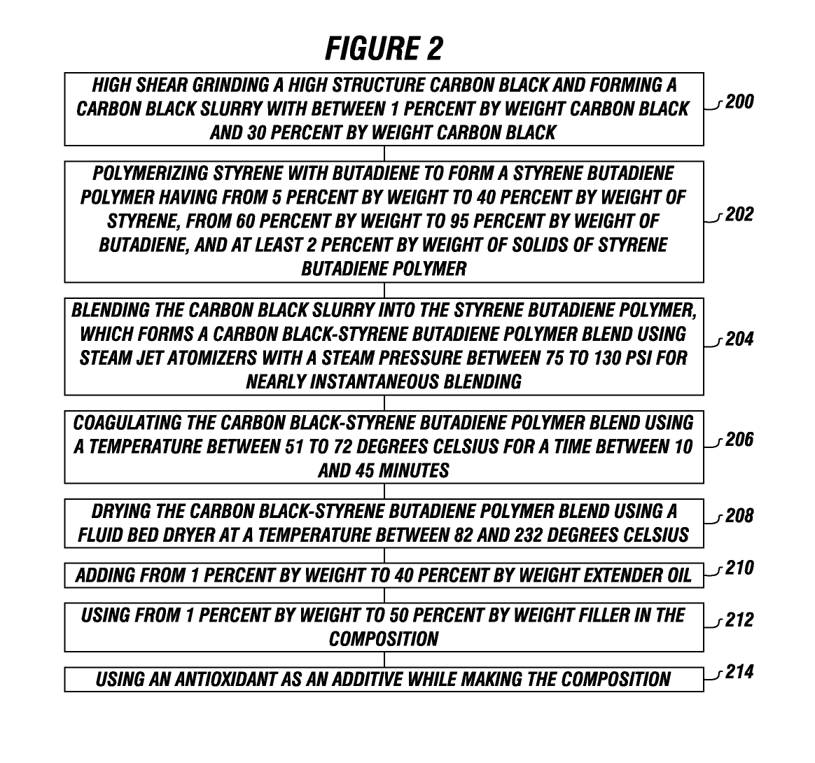

FIG. 2 depicts another embodiment of the process to make the styrene butadiene polymer composition with a high structure carbon black using a continuous process.

Step 200 can include high shear grinding a high structure carbon black and forming a carbon black slurry with between 1 percent by weight carbon black and 30 percent by weight carbon black.

Step 202 can include polymerizing styrene with butadiene to form a styrene butadiene polymer having from 5 percent by weight to 40 percent by weight of styrene, from 60 percent by weight to 95 percent by weight of butadiene, and at least 2 percent by weight of solids of styrene butadiene polymer.

Step 204 can include blending the carbon black slurry into the styrene butadiene polymer, which forms a carbon black-styrene butadiene polymer blend using steam jet atomizers with a steam pressure between 75 psi to 130 psi for nearly instantaneous blending.

Step 206 can include coagulating the carbon black-styrene butadiene polymer blend using a temperature between 51 degrees Celsius to 72 degrees Celsius for a time between 10 minutes and 45 minutes.

Step 208 involves drying the carbon black-styrene butadiene polymer blend using a fluid bed dryer at a temperature between 82 degrees Celsius and 232 degrees Celsius.

The styrene monomer with butadiene monomer can be cross-linked and/or chemically bound.

An article can be made from the styrene butadiene polymer composition as made by the method of FIG. 2.

The high structure carbon black can be 100 percent ASTM 100 series carbon black.

Step 210 can include adding from 1 percent by weight to 40 percent by weight extender oil.

Step 212 can include using from 1 percent by weight to 50 percent by weight filler in the composition.

The filler for this embodiment can be: ground pecan shells, diatomaceous earth, silage, cellulosic materials, ground peanut shells, talc, ground coal, ground bagasse, ash, perlite, clay, calcium carbonate, biomass, or combinations thereof.

Step 214 can include using an antioxidant as an additive while making the composition.

The antioxidant can be a phenolic antioxidant, a phosphite, a bisphenol, an amine or combinations thereof.

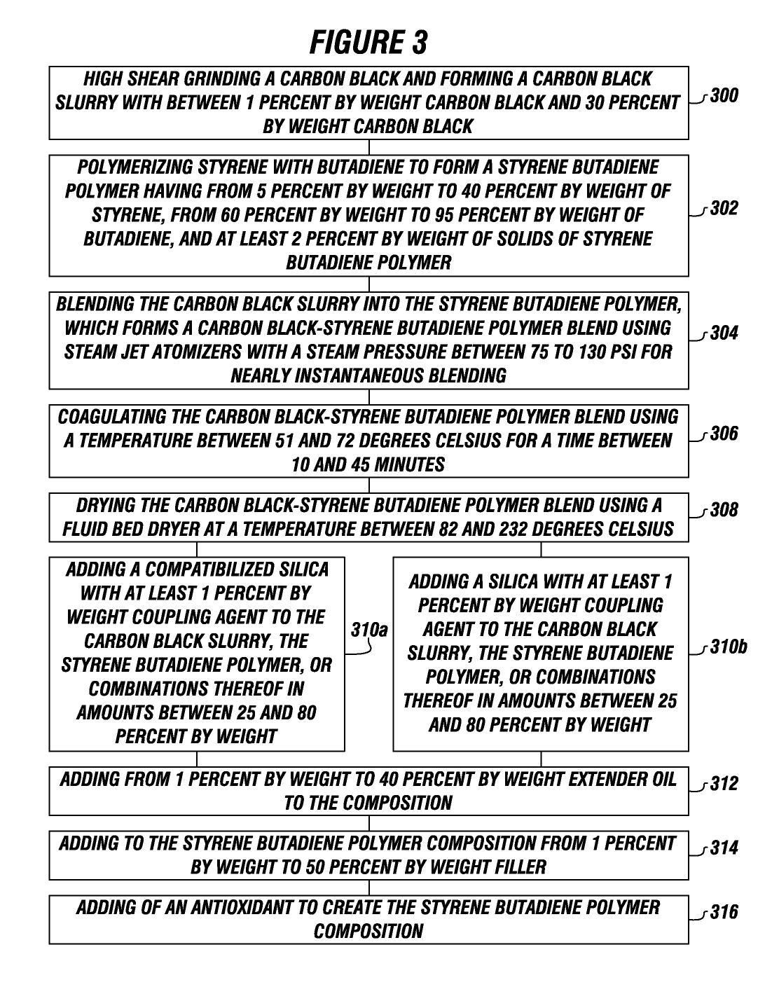

FIG. 3 shows another continuous methodology for making a styrene butadiene polymer composition containing a carbon black.

Step 300 can include high shear grinding a carbon black and forming a carbon black slurry with between 1 percent by weight carbon black and 30 percent by weight carbon black.

Step 302 can include polymerizing styrene with butadiene to form a styrene butadiene polymer having from 5 percent by weight to 40 percent by weight of styrene, from 60 percent by weight to 95 percent by weight of butadiene, and at least 2 percent by weight of solids of styrene butadiene polymer.

Step 304 can include blending the carbon black slurry into the styrene butadiene polymer, which forms a carbon black-styrene butadiene polymer blend using steam jet atomizers with a steam pressure between 75 psi to 130 psi for nearly instantaneous blending.

Step 306 can include coagulating the carbon black-styrene butadiene polymer blend using a temperature between 51 degrees Celsius and 72 degrees Celsius for a time between 10 minutes and 45 minutes.

Step 308 can include drying the carbon black-styrene butadiene polymer blend using a fluid bed dryer at a temperature between 82 degrees Celsius and 232 degrees Celsius.

Step 310A can include adding a compatibilized silica with at least 1 percent by weight coupling agent to the carbon black slurry, the styrene butadiene polymer, or combinations thereof in amounts between 25 percent and 80 percent by weight.

Step 310B can include adding a silica with at least 1 percent by weight coupling agent to the carbon black slurry, the styrene butadiene polymer, or combinations thereof in amounts between 25 percent and 80 percent by weight.

Either silica or compatibilized silica can be used independently, as illustrated in steps 310A and 310B. However, both silica and compatibilized silica can be used to gain commercial advantages, such as toughness with reduced manufacturing costs. Therefore, the method can include step 310A, step 310B, or both.

Step 312 can include adding from 1 percent by weight to 40 percent by weight extender oil to the composition.

Step 314 can include adding to the styrene butadiene polymer composition from 1 percent by weight to 50 percent by weight filler.

Step 316 can include adding of an antioxidant to create the styrene butadiene polymer composition.

In one or more embodiments disclosed herein, the carbon black can be a blend of two different carbon blacks. The first carbon black can meet the 2010 ASTM 100 series definition, having an average nitrogen area of 120 to 150 square meters per gram. The second carbon black can meet the 2010 ASTM 300 series definition, having an average nitrogen area of 70 square meters per gram to 99 square meters per gram. The ratio between the first carbon black and the second carbon black can range from 80:20 to 20:80.

While these embodiments have been described with emphasis on the embodiments, it should be understood that within the scope of the appended claims, the embodiments might be practiced other than as specifically described herein.

What is claimed is:

1. A continuous flow process for making a styrene butadiene polymer composition with a high structure carbon black, the process comprising:
a. continuously high shear grinding a high structure carbon black and forming a carbon black slurry with from 1 percent by weight to 30 percent by weight carbon black, with a nitrogen surface area greater than 150 square meters per gram, wherein the high shear grinding is performed using steam jet atomizers with a steam pressure from 75 psi to 130 psi;
b. continuously polymerizing a styrene monomer with a liquid 1,3-butadiene monomer to form a styrene butadiene polymer having from 5 percent by weight to 40 percent by weight of the styrene monomer, from 60 percent by weight to 95 percent by weight of the liquid 1,3-butadiene monomer, and at least 2 percent by weight of solids of the styrene butadiene polymer, wherein the polymerizing is performed using a hydroperoxide of less than 10 percent based on a total weight of the monomers, and wherein the styrene butadiene polymer has ratio of styrene to liquid 1,3-butadiene ranging from 0.06:1 to 0.14:1;
c. continuously blending the carbon black slurry into the styrene butadiene polymer into a vessel and forming a carbon black-styrene butadiene blend;
d. continuously coagulating at least 80 percent of the carbon black-styrene butadiene blend at a temperature ranging from 51 degrees Celsius to 72 degrees Celsius for a time ranging from 10 minutes to 45 minutes;
e. continuously separating the carbon black-styrene butadiene blend from water in the carbon black-styrene butadiene blend and reducing a water content in the carbon black-styrene butadiene blend to less than 10 percent; and
f. continuously drying the carbon black-styrene butadiene polymer blend at a temperature ranging from 82 degrees Celsius to 232 degrees Celsius until the water content ranges from 0.15 percent to 2 percent, forming the styrene butadiene polymer composition with a Mooney unit ranging from 40 to 90 as measured by MS 1+4 at 100 degrees Celsius at a continuous flow rate ranging from 3,000 pounds to 20,000 pounds of the styrene butadiene polymer per hour.

2. The process of claim 1, further comprising adding a compatibilized silica to the vessel, wherein the compatibilized silica has at least 1 percent by weight of a coupling agent to the carbon black slurry, the styrene butadiene polymer, or combinations thereof, and wherein the compatibilized silica is added in an amount ranging from 25 percent to 80 percent by weight.

3. The process of claim 2, wherein form 1 percent to 15 percent of the coupling agent is used.

4. The process of claim 3, wherein the coupling agent is an organo silicon compound.

5. The process of claim 1, further comprising adding a silica to the vessel with at least 1 percent by weight of a coupling agent to the carbon black slurry, the styrene butadiene polymer, or combinations thereof, wherein the silica is added in amounts ranging from 25 percent to 80 percent by weight.

6. The process of claim 1, wherein the high shear grinding is performed by ball mill grinding, hammer mill grinding, cryogenic grinding, mechanical grinding, or combinations thereof, and wherein water is added to the ground high structure carbon black to form the carbon black slurry.

7. The process of claim 1, wherein the high structure carbon black comprises an ASTM 100 series carbon black according to ASTM 2010 standards.

8. The process of claim 1, wherein the carbon black slurry comprises from 1 percent by weight to 13 percent by weight carbon black solids in water.

9. The process of claim 1, wherein continuously drying the carbon black-styrene butadiene polymer blend removes water from the styrene butadiene polymer until less than 2 percent by weight of water exists in the styrene butadiene polymer.

10. The process of claim 1, further comprising chemically binding the styrene monomer with the liquid 1,3-butadiene monomer.

11. A styrene butadiene polymer composition made from a styrene butadiene polymer blend containing a high structure carbon black, wherein the styrene butadiene polymer composition with the high structure carbon black is made by a continuous process comprising:
a. high shear grinding a high structure carbon black and forming a carbon black slurry with from 1 percent by weight to 30 percent by weight carbon black;
b. polymerizing styrene with liquid 1,3-butadiene to form a styrene butadiene polymer having from 5 percent by weight to 40 percent by weight of the styrene, from 60 percent by weight to 95 percent by weight of the liquid 1,3-butadiene, and at least 2 percent by weight of solids of the styrene butadiene polymer;
c. blending the carbon black slurry into the styrene butadiene polymer, forming a carbon black-styrene butadiene blend using steam jet atomizers with a steam pressure from 75 psi to 130 psi;
d. coagulating the carbon black-styrene butadiene blend using a temperature ranging from 51 degrees Celsius to 72 degrees Celsius for a time ranging from 10 minutes to 45 minutes; and
e. drying the carbon black-styrene butadiene blend using a fluid bed dryer at a temperature ranging from 82 degrees Celsius to 232 degrees Celsius.

12. The styrene butadiene polymer composition of claim 11, wherein the styrene and the liquid 1,3-butadiene are chemically bound in the styrene butadiene polymer.

13. The styrene butadiene polymer composition of claim 11, wherein the high structure carbon black comprises 100 percent of an ASTM 100 series carbon black.

14. The styrene butadiene polymer composition of claim 11, further comprising from 1 percent by weight to 40 percent by weight of an extender oil.

15. The styrene butadiene polymer composition of claim 14, wherein the extender oil comprises: a synthetic oil, an aromatic oil, a naphthenic oil, a hydrocarbon based oil, a polycyclic aromatic hydrocarbon oil, or combinations.

16. The styrene butadiene polymer composition of claim 11, further comprising from 1 percent by weight to 50 percent by weight of a filler.

17. The styrene butadiene polymer composition of claim 16, wherein the filler is: ground pecan shells, diatomaceous earth, silage, cellulosic materials, ground peanut shells, talc, ground coal, ground bagasse, ash, perlite, clay, calcium carbonate, biomass, or combinations thereof.

18. The styrene butadiene polymer composition of claim 11, further comprising an antioxidant.

19. The styrene butadiene polymer composition of claim 18, wherein the antioxidant is a phenolic antioxidant, a phosphite, a bisphenol, an amine, or combinations thereof.

20. An article made from the styrene butadiene polymer composition of claim 11.

21. The article of claim 20, wherein the article is a floor mat, a tire, a belt, a roller, footwear, wire and cable jacketing, roof edging, a tubular hose, a marine impact bumper, an industrial belt, a non-automotive tire, non-latex gloves, a mining belt, a bearing, a gas mask, a conduit, or a pneumatic tire.

22. A styrene butadiene polymer composition made from a styrene butadiene polymer blend containing a carbon black, wherein the styrene butadiene polymer composition with the carbon black is made by a continuous process comprising:
a. high shear grinding a carbon black and forming a carbon black slurry with from 1 percent by weight to 30 percent by weight of carbon black;
b. polymerizing styrene with liquid 1,3-butadiene to form a styrene butadiene polymer having from 5 percent by weight to 40 percent by weight of the styrene, from 60 percent by weight to 95 percent by weight of the liquid 1,3-butadiene, and at least 2 percent by weight of solids of the styrene butadiene polymer;
c. blending the carbon black slurry into the styrene butadiene polymer to form a carbon black-styrene butadiene blend using steam jet atomizers with a steam pressure from 75 psi to 130 psi;
d. coagulating the carbon black-styrene butadiene blend using a temperature ranging from 51 degrees Celsius to 72 degrees Celsius for a time ranging from 10 minutes to 45 minutes; and
e. drying the carbon black-styrene butadiene blend using a fluid bed dryer at a temperature ranging from 82 degrees Celsius to 232 degrees Celsius.

23. The styrene butadiene polymer composition of claim 22, wherein the carbon black is a blend of a first carbon black and a second carbon black, wherein the first carbon black meets a 2010 ASTM 100 series definition having an average nitrogen area ranging from 120 to 150 square meters per gram, wherein the second carbon black meets a 2010 ASTM 300 series definition having an average nitrogen area ranging from 70 square meters per gram to 99 square meters per gram, and wherein a ratio between the first carbon black and the second carbon black ranges from 80:20 to 20:80.

24. The styrene butadiene polymer composition of claim 22, further comprising from 25 percent to 80 weight percent of a compatibilized silica with at least 1 percent by weight of a coupling agent in the carbon black slurry, the styrene butadiene polymer, or combinations thereof.

25. The styrene butadiene polymer composition of claim 22, further comprising from 25 percent to 80 weight percent of a silica with at least 1 percent by weight of a coupling agent in the carbon black slurry, the styrene butadiene polymer, or combinations thereof.

26. The styrene butadiene polymer composition of claim 22, further comprising from 1 percent by weight to 40 percent by weight of an extender oil.

27. The styrene butadiene polymer composition of claim 26, wherein the extender oil comprises a synthetic oil, an aromatic oil, a naphthenic oil, a hydrocarbon based oil, a polycyclic aromatic hydrocarbon oil, or combinations.

28. The styrene butadiene polymer composition of claim 22, further comprising from 1 percent by weight to 50 percent by weight of a filler.

29. The styrene butadiene polymer composition of claim 28, wherein the filler is: ground pecan shells, diatomaceous earth, silage, cellulosic materials, ground peanut shells, talc, ground coal, ground bagasse, ash, perlite, clay, calcium carbonate, biomass, or combinations thereof.

30. The styrene butadiene polymer composition of claim 22, further comprising an antioxidant.

31. The styrene butadiene polymer composition of claim 30, wherein the antioxidant is a phenolic antioxidant, a phosphite, a bisphenol, an amine, or combinations thereof.

32. The styrene butadiene polymer composition of claim 22, wherein the styrene is chemically bound with the liquid 1,3-butadiene.

33. An article made from the styrene butadiene polymer composition of claim 22.

34. The article of claim 33, wherein the article is a floor mat, a tire, a belt, a roller, footwear, wire and cable jacketing, roof edging, a tubular hose, a marine impact bumper, an industrial belt, a non-automotive tire, non-latex gloves, a mining belt, a bearing, a gas mask, a conduit, or a pneumatic tire.
